(19) United States
(12) Patent Application Publication
(10) Pub. No.: US 2008/0215416 A1
(43) Pub. Date: Sep. 4, 2008

(54) SEARCHABLE INTERACTIVE INTERNET ADVERTISEMENTS

(75) Inventor: Emil Ismalon, Tel-Aviv (IL)

Correspondence Address: DARBY & DARBY P.C., P.O. BOX 770, Church Street Station, New York, NY, 10008-0770, US

(73) Assignee: COLLARITY, INC., Palo Alto, CA (US)

(21) Appl. No.: 12/023,564

(22) Filed: Jan. 31, 2008

Related U.S. Application Data
(60) Provisional application No. 60/887,580, filed on Jan. 31, 2007.

(51) Int. Cl. G06Q 30/00; G06F 17/30; G06F 7/10

(52) U.S. Cl. 705/10; 707/5; 705/14; 707/E17.017

(57) ABSTRACT

A computer-implemented method is provided, including presenting, to first users that visit one or more first websites, an interactive advertisement that includes search functionality for searching a second website different from the first websites. Respective first search queries, each of which consists of one or more first query terms, are received from the first users, via a search field of the search functionality. Respective first search result listings are presented to the first users, each of which first search results includes first search results associated with respective search result documents of the second website. An advertisement profile is constructed for the advertisement that represents interactions between the first users and a plurality of the first search results. The advertisement is presented to a second user that visits one of the first websites, and the search functionality is configured responsively to the advertisement profile. Other embodiments are also described.

### CROSS-REFERENCES TO RELATED APPLICATIONS

The present application claims priority from U.S. Provisional Application 60/887,580, filed Jan. 31, 2007, entitled, “Searchable banner display and apparatus that enables exploring destination content prior to reaching it,” which is assigned to the assignee of the present application and is incorporated herein by reference.

### FIELD OF THE INVENTION

The present invention relates generally to online advertising, and specifically to interactive advertisements.

### BACKGROUND OF THE INVENTION

Internet search engines have become fundamental tools for nearly all users seeking information and sites on the World Wide Web (WWW). Users can find vast amounts of data and select the data that appears to best match specific search criteria. Free-text searches are generally performed by providing a search phrase including one or more keywords, and optionally Boolean operators. The most widely used free-text search engines currently are provided by Google, Inc. and Yahoo, Inc. Most large websites offer site-specific search tools for finding content on the webpages of the website.

Internet advertisements are often targeted to website visitors. Some search engines use search queries to target advertisements to search engine users on the search results pages. For example, Google's AdWord program performs such targeting.

Internet advertisements are often presented on a webpage in the form of banner ads that comprise rectangular boxes including graphical components. When a visitor to a website selects one of these banner ads by clicking on it, embedded hypertext links typically direct the viewer to the advertiser's website. This selection process is referred to as “click-through.” The “click-through rate” of an ad is the ratio of the number of click-throughs to the number of impressions of the ad, i.e., the number of times an ad is viewed.

Internet advertisements are increasingly presented on or via a webpage in the form of widgets, which comprise portable pieces of code that can be installed and executed within a webpage or otherwise on a user's personal computer. Widget ads are often interactive, and present dynamic content provided by the advertiser. For example, Google's AdSense uses widgets (referred to as “gadgets”) as one vehicle for distributing advertisements.

A whitepaper entitled, “Searchable Banners: The Next Wave for Online Databases” (Borrell Associates Inc., November 2005), which is incorporated herein by reference, describes searchable interactive banner ads that return search results in the banner, without requiring the user to click through to a different webpage.

David Berkowitz, in an article entitled, “Banner Ads: The New Search Engine,” SearchINSIDER (Dec. 6, 2005), which is incorporated herein by reference, describes an online advertising product called Search&Display (Inoventiv Canada Corp., Stoney Creek, Ontario, Canada), which allows consumers to search within a banner ad and then access content without clicking through to another site. For example, an ad from an automaker could allow consumers to search for available cars from a local dealership, get a price quote, order a brochure, and schedule a test drive.

US Patent Application Publication 2005/0086283 to Marshall, which is incorporated herein by reference, describes a system for transacting retrieval of real estate property listings over a network and dynamically transmitting the listings to Flash banners enabled with dynamic messaging technology residing on an ad server.

International Publication WO 07/124430 to Ismalon, which is assigned to the assignee of the present application and is incorporated herein by reference, describes a method including presenting to a user a range of levels of personalization of search results, including a personalized level, a global level that is not personalized, and a community level between the personalized level and the global level. An indication of a desired one of the levels, and a search query consisting of one or more query terms, are received from the user. Responsively to the search query, a search result listing is generated. At least a portion of the search result listing is ranked at least in part responsively to the indication, and at least a portion of the ranked search result listing is presented to the user.

US Patent Application Publication 2004/0059708 to Dean et al., which is incorporated herein by reference, describes techniques for improving the relevance of advertisements to a user's interests. In one implementation, the content of a web page is analyzed to determine a list of one or more topics associated with that web page. An advertisement is considered to be relevant to that web page if it is associated with keywords belonging to the list of one or more topics. One or more of these relevant advertisements may be provided for rendering in conjunction with the web page or related web pages.

U.S. Pat. No. 7,249,053 to Wohlers et al., which is incorporated herein by reference, describes techniques for sequentially displaying first and second messages in the same presentation vehicle.

US Patent Application Publication 2007/0265922 to Dumond et al., which is incorporated herein by reference, describes electronic advertisement techniques for delivering, via the Internet, a fully interactive database of vehicle inventory contained within a banner advertisement. The techniques enable users to browse inventory of cars for sale, including photos, within the banner advertisement itself without obstructing the viewing and reading of other website content.

International Application WO 00/62171 to Glazer, which is incorporated herein by reference, describes techniques for managing Internet banner display rights. A party acquires long-term banner display rights on published web sites of other entities, in a manner so as to ensure full and continual control over the content, look, and functionality of the acquired banner space. The Internet banner is multifunctional, utilizing menus, links, and similar user interface items to operate as a portal to a variety of informational content and services, such as e-commerce, search engines, and the like. These services might be provided by the party which owns the banner space, or by third parties. The banners which appear in the spaces acquired from multiple publishing sites are organized into a networked system, to provide users with integrated and consistent access to the available services. The entity which provides the content and services through the banners can enter into arrangements with end users, to provide incentives for users to access the banners as well as enhance the users' experience.

International Application WO 01/29727 to Green et al., which is incorporated herein by reference, describes a method of interactive advertising for the Internet, in which a banner is displayed in an ad space of a Web page. The banner allows a user to make a purchase transaction or a view an inventory of goods and services, with descriptions, all without leaving the Web page. The user transaction takes place through the banner, and therefore there is no need for the user to leave the Web page in order to make a purchase. The ad space and program according to the invention provide a customized appearance that closely resembles the branding of the advertiser.

US Patent Application Publication 2005/0091111 to Green et al., which is incorporated herein by reference, describes a method of interactive advertising for the Internet, in which a commercial link for an ad space is embedded in the text of a Web page. The contextual targeting for the page is determined by analyzing the overall content of the page or determining the presence of individual keywords within the text content of the page. A keyword that is visually distinguished from the surrounding page content triggers an ad space to display a message, which may include a product related to the text. In some embodiments, the ad space allows a user to make a purchase transaction or view an inventory of goods and services, with descriptions, all without leaving the Web page. The web page is analyzed to determine appropriate keywords within the text to associate with the ad space. Upon user interaction with the keyword, an ad space according to the invention provides a customized message that is contextually targeted to the user.

U.S. Pat. Nos. 6,615,238, 6,917,961, and 7,233,973 to Melet et al., which is incorporated herein by reference, describes a host Web page that includes a evolving interactive dialog box wherein an Internet user may enter user data to be processed. When the user completes entering data in a first revolution of the interactive dialog box, the first revolution is replaced with a second revolution of the evolving interactive dialog box without disturbing or affecting any other part of the host Web page being displayed. Thus, the user is not driven or distracted away from the host Web site while providing data to be processed. The evolving interactive dialog box is especially well-suited to operation with an interrogation processing system which receives questions from users via the Internet and forwards the questions, preferably via the Internet, to sponsors selected based on information pertaining to the question.

US Patent Application Publication 2007/0226082 to Leal, which is incorporated herein by reference, describes techniques that allow a consumer to use a graphical tool that summarizes, compares and browses multiple offers for products or services over a network or communications medium such as via the Internet. Potential purchasers can make declarations to buy, which sellers can use to generate improved and customized offers.

US Patent Application Publication 2006/0218036 to King et al., which is incorporated herein by reference, describes a system and method for serving questionnaire content within a banner ad, the system including a web server, a web browser that requests and receives a web page including the banner ad from the web server and a questionnaire server for serving the questionnaire content. The banner ad requests and receives a Flash program for displaying questionnaire content received from the questionnaire server, the questionnaire content comprising multi-page, dynamic questionnaire content that allows users to interact with the banner ad without clicking-through to the questionnaire.

The following references, all of which are incorporated herein by reference, may be of interest:

US Patent Application Publication 2005/0033641 to Jha et al.

PCT Publication WO 06/103616 to Pitchers

U.S. Pat. No. 5,987,457 to Ballard

US Patent Application Publication 2005/0076003 to DuBose et al.

U.S. Pat. No. 6,732,088 to Glance

U.S. Pat. No. 6,772,150 to Whitman et al.

US Patent Application Publication 2003/0123443 to Anwar

U.S. Pat. No. 6,636,848 to Aridor et al.

U.S. Pat. No. 4,823,306 to Barbic et al.

U.S. Pat. No. 6,513,036 to Fruensgaard et al.

US Patent Application Publication 2002/0133483 to Klenk et al.

U.S. Pat. No. 5,926,812 to Hilsenrath et al.

U.S. Pat. No. 6,289,353 to Hazlehurst et al.

US Patent Application Publication 2005/0055341 to Haahr et al.

U.S. Pat. No. 6,363,379 to Jacobson et al.

U.S. Pat. No. 6,347,313 to Ma et al.

U.S. Pat. No. 6,321,226 to Garber et al.

U.S. Pat. No. 6,189,002 to Roitblat

U.S. Pat. No. 6,167,397 to Jacobson et al.

U.S. Pat. No. 5,864,845 to Voorhees et al.

U.S. Pat. No. 5,825,943 to DeVito et al.

US Patent Application Publication 2005/0144158 to Capper et al.

US Patent Application Publication 2005/0114324 to Mayer

US Patent Application Publication 2005/0055341 to Haahr et al.

U.S. Pat. No. 5,857,179 to Vaithyanathan et al.

U.S. Pat. No. 7,139,755 to Hammond

U.S. Pat. No. 7,152,061 to Curtis et al.

U.S. Pat. No. 6,904,588 to Reddy et al.

U.S. Pat. No. 6,842,906 to Bowman-Amuha

U.S. Pat. No. 6,539,396 to Bowman-Amuha

US Patent Application Publication 2004/0249809 to Ramani et al.

US Patent Application Publication 2003/0058277 to Bowman-Amuha

U.S. Pat. No. 6,925,460 to Kummamuru et al.

U.S. Pat. No. 6,920,448 to Kincaid et al.

US Patent Application Publication 2006/0074883 to Teevan et al.

US Patent Application Publication 2006/0059134 to Palmon et al.

US Patent Application Publication 2006/0047643 to Chaman

US Patent Application Publication 2005/0216434 to Haveliwala et al.

US Patent Application Publication 2003/0061206 to Qian

US Patent Application Publication 2002/0073088 to Beckmann et al.

### SUMMARY OF THE INVENTION

Some embodiments of the present invention provide an advertising system that presents an interactive internet advertisement, such as a banner ad or widget, having search functionality for enabling searching of the content of an advertised website, and presenting, in the interactive advertisement, search results or other content related to the search. The search results or other content typically include links to the webpages of the advertised website. The advertising system configures the search functionality responsively to observed interactions of visitors with the advertised website. For example, the advertising system may populate a search field of the advertisement with a default search query responsively to the observed interactions. Alternatively or additionally, the system configures the search functionality responsively to a profile of the user viewing the advertisement, and/or a community of users to which the user belongs.

In some embodiments of the present invention, the advertising system ranks the search results responsively to the observed interactions of the visitors with the advertised website. For example, the system may rank more highly particular search results selected by visitors to the advertised website who performed similar searches of the advertised website and selected these particular search results. Alternatively or additionally, in response to an initial search query entered into the search field of the advertisement, the advertising system presents search refinement options selected responsively to the observed interactions of the visitors with the advertised website. The viewer of the advertisement may add one or more of these refinement options to the initial search query, in order to generate a revised search query of greater relevance to the viewer.

The advertising system thus enables the viewer of the advertisement to interact with the advertised website while remaining at the website on which the advertisement is presented. If the viewer decides to click through to the advertised website, the content presented to the viewer in response to this interaction enables the viewer to click though directly to webpages of the advertised website most likely to be of interest to the viewer. The population of the search field of the advertisement with a default search query likely to be meaningful to the viewer increases the likelihood that the viewer will interact with the advertisement, and will choose to click through to the advertiser website.

In some embodiments of the present invention, visitors of the advertised website perform searches of the advertised website using search queries comprising one or more query terms. The advertising system constructs an association graph that includes at least a portion of the query terms as vertices. The system uses the association graph to configure the search functionality of the interactive advertisement. For some applications, the system monitors interactions of a user during searches conducted by the user, and constructs an association graph for the user that includes as vertices search terms used by the user. When the user views the interactive advertisement, the system configures the search functionality of the advertisement responsively to a comparison of the user's association graph and the association graph of the advertisement.

For some applications, the system configures the search functionality by populating a search field of the search functionality with a default search query determined using the association graph. For example, the system may include in the default search query terms that dominate searches performed in the advertised website by its visitors. Alternatively or additionally, the system configures the search functionality by presenting search refinement options selected using the association graph.

In some embodiments of the present invention, the advertisement system is configured to receive from the user an indication of a desired level of personalization. For example, levels of personalization may include a personalized level, a global level that is not personalized, and a community level between the personalized level and the global level. Based on the desired level of personalization, the system configures search results presented to the user, and/or search refinement options presented to the user.

In some embodiments of the present invention, the advertisement system constructs an advertisement profile for the interactive advertisement. The advertisement profile represents interactions between first viewers of the advertisement and results of searches performed by the users in the advertisement. The system uses the profile to customize the search functionality of the advertisement for a second viewer of the advertisement. For some applications, the system ranks search results presented to the second viewer responsively to the advertisement profile. Alternatively or additionally, the system generates a set of refinement terms including at least one query term searched by the first users and included in the advertisement profile. The query term is selected for inclusion in the set responsively to a level of association in the advertisement profile of the query term with the query terms searched by the second user.

In some embodiments of the present invention, the advertisement system analyzes content of webpages of websites on which it may be appropriate to display the interactive advertisement. The system generates a set of one or more webpage keywords characterizing each of the webpages. The system determines respective levels of relevance of the interactive advertisement to each of the webpages by performing a comparison of the webpage keywords of the webpage and the advertisement profile. The system determines on which webpages to display the interactive advertisement responsively to the levels of relevance.

For some applications, the advertisement profile includes an advertisement association graph (AAG) that includes as vertices at least a portion of one or more first query terms searched by the first users. Typically, the search query searched by the second user consists of one or more second query terms included in a portion of the vertices of the AAG.

There is therefore provided, in accordance with an embodiment of the present invention, a computer-implemented method including:

presenting, to first users that visit one or more first websites, an interactive advertisement that includes search functionality for searching a second website different from the first websites;

receiving from the first users, via a search field of the search functionality, respective first search queries, each of which consists of one or more first query terms;

presenting to the first users respective first search result listings, each of which includes first search results (e.g., URLs or snippets) associated with respective search result documents of the second website;

constructing an advertisement profile for the advertisement that represents interactions between the first users and a plurality of the first search results;

presenting the advertisement to a second user that visits one of the first websites; and

configuring the search functionality responsively to the advertisement profile.

For some applications, constructing the advertisement profile includes:

responsively to the interactions, defining a plurality of communities, each of which includes some of the first users;

generating respective community profiles for the communities and storing the community profiles in the advertisement profile;

receiving a profile of the second user; and

upon finding that the profile of the second user correlates with one of the community profiles, configuring search functionality using the community profile.

In an embodiment, the advertisement profile includes an advertisement association graph (AAG) that includes at least a portion of the first query terms as vertices. For some applications, constructing the advertisement profile includes including as one of the vertices a term included in a user profile of one of the first users, which term was not included in the respective one of the first search queries.

For some applications, configuring the search functionality includes: receiving from the second user a second search query, via the search field; responsively to the second search query, generating a second search result listing including documents of the second website; ranking at least a portion of the second search result listing responsively to a comparison of the advertisement profile and at least a portion of the documents of the second search result listing; and presenting at least a portion of the ranked second search result listing to the second user in the advertisement. For some applications, the advertisement profile includes an advertisement association graph (AAG) that includes at least a portion of the first query terms as vertices, and the second search query consists of one or more second query terms included in a portion of the vertices of the AAG.

For some applications, configuring the search functionality includes: receiving from the second user a second search query, via the search field; responsively to the second search query, selecting at least one of the first query terms for inclusion in a set of refinement terms, responsively to a level of association in the advertisement profile of the first query term with the second query terms; presenting the set of refinement terms to the second user in the advertisement; responsively to a selection of one of the refinement terms by the second user, adding the selected refinement term to the second search query to generate a third search query; and presenting, to the second user in the advertisement, a second search result listing responsively to the third search query. For some applications, the advertisement profile includes an advertisement association graph (AAG) that includes at least a portion of the one or more first query terms as vertices, and the second search query consists of one or more second query terms included in a portion of the vertices of the AAG.

There is further provided, in accordance with an embodiment of the present invention, a computer-implemented method including:

presenting an interactive advertisement to a plurality of first users that visit one or more first websites, which advertisement includes a search field for searching a second website different from the first websites;

during searches performed by the first users, receiving from the first users respective search queries via the search field;

presenting to the first users respective search result listings;

constructing an advertisement profile for the advertisement that represents interactions between the first users and the advertisement during the searches;

analyzing content of at least one webpage of a third website different from the second website, to generate a set of one or more webpage keywords characterizing the webpage;

determining a level of relevance of the interactive advertisement to the webpage by performing a comparison of the webpage keywords and the advertisement profile; and

presenting the advertisement to a second user that visits the third website, responsively to the level of relevance.

In an embodiment, each of the search queries consists of one or more query terms, and constructing the advertisement profile includes including at least a portion of the query terms in the advertisement profile.

For some applications, each of search result listings includes one or more snippets associated with one or more respective search result documents of the second website, each of which snippets includes one or more snippet keywords, and constructing the advertisement profile includes including at least a portion of the snippet keywords in the advertisement profile. For some applications, constructing the advertisement profile includes: receiving respective search result selections of the snippets from the first users; and including at least a portion of the snippet keywords of the search result selections in the advertisement profile.

In an embodiment, each of the search queries includes one or more query terms, the advertisement profile includes an advertisement association graph (AAG), and constructing the advertisement profile includes including at least a portion of the query terms as vertices of the AAG.

There is still further provided, in accordance with an embodiment of the present invention, a computer-implemented method including:

receiving, via a network, a request from a user to access a webpage of a first website;

examining a referrer URL to determine whether the user was referred to the webpage from a search engine;

upon finding that the user was referred, extracting from the referrer URL a first search query entered by the user into the search engine;

presenting to the user an interactive advertisement that includes a search field for searching a second website different from the first website;

populating the search field with a default second search query determined responsively to the first search query;

upon receiving an indication from the user to perform a search using the default second search query, generating search results by performing a search of the second website using the default second search query; and

presenting at least a portion of the search results to the user in the interactive advertisement.

There is additionally provided, in accordance with an embodiment of the present invention, a computer-implemented method including:

presenting, to a user visiting a first website, an interactive advertisement that includes a search field for searching a second website different from the first website;

receiving a search query from the user via the search field;

generating a first set of search results by performing a search of the second website using the search query;

upon finding that a relevancy of the first set of search results to the search query does not exceed a threshold relevancy, generating a second set of search results by performing, using the search query, a search of a third website different from the first and second websites; and

presenting at least a portion of the second set of search results in the interactive advertisement.

There is yet additionally provided, in accordance with an embodiment of the present invention, a computer-implemented method including:

observing first interactions of a plurality of first users with a first website;

responsively to the first interactions, defining a plurality of communities, each of which includes some of the first users;

generating respective community profiles for the communities;

presenting, to a second user different from the first users, an interactive advertisement that advertises the first website, when the second user visits a second website different from the first website;

receiving a profile of the second user; and

upon finding that the profile of the second user correlates with one of the community profiles, configuring an interactive element of the interactive advertisement using the community profile.

In an embodiment, the first interactions include searches performed by the first users including respective search queries having query terms, and generating the community profiles includes including at least a portion of the query terms in the community profiles. For some applications, the community profiles include respective community association graphs, each of which includes some of the query terms as vertices.

In an embodiment, the interactive element includes search functionality of the interactive advertisement.

For some applications, receiving the profile of the second user includes deriving the profile at least in part from search terms included in a referrer URL of a request received from the second user to access the second website. Alternatively or additionally, receiving the profile of the second user includes including terms from previous searches conducted by the second user.

There is also provided, in accordance with an embodiment of the present invention, a computer-implemented method including:

generating a profile for an internet advertisement;

receiving, via a network, at least one request from at least one first user to access a webpage;

examining a referrer URL of the request to determine whether the first user was referred to the webpage from a search engine;

upon finding that the first user was referred, extracting from the referrer URL a search query entered by the first user into the search engine;

generating a set of one or more webpage keywords characterizing the webpage, which set includes one or more terms of the search query extracted from the referrer URL;

determining a level of relevance of the advertisement to the webpage by performing a comparison of the webpage keywords and the advertisement profile; and

presenting the advertisement to a second user that visits the webpage, responsively to the level of relevance.

There is further provided, in accordance with an embodiment of the present invention, a computer-implemented method including:

presenting to a user an advertisement that advertises a first website, when the user visits a second website different from the first website, the advertisement including at least one navigation element directed to the first website;

receiving a profile of the user; and

upon the user activating the navigation element, selecting one of a plurality of webpages of the first website responsively to the profile of the user, and presenting the selected webpage to the user.

For some applications, selecting includes: calculating a correlation between the profile of the user and a profile of the first website; responsively to the correlation, determining subject matter of the first website that may be of interest to the user; and selecting the one of the plurality of webpages because it includes at least some of the subject matter.

For some applications, selecting includes: generating one or more terms that are correlated between the profile of the user and a profile of the first website; performing a search of the first website using the one or more terms as a query; and selecting the one of the plurality of webpages because it is a high-ranking result of the search.

For some applications, the user includes a first user, and selecting includes: observing interactions with the first website of a plurality of second users different from the first user; responsively to the interactions, defining a plurality of communities, each of which includes some of the second users; generating respective community profiles for the communities; finding with which of the community profiles the profile of the first user most highly correlates; and selecting the one of the plurality of webpages because it includes subject matter reflected in the most highly correlated of the community profiles.

For some applications, receiving the profile of the user includes deriving the profile at least in part from search terms included in a referrer URL of a request received from the user to access the second website. Alternatively or additionally, receiving the profile of the user includes including terms from previous searches conducted by the user.

There is still further provided, in accordance with an embodiment of the present invention, a computer-implemented method including:

receiving, from first users performing searches on a first website, a plurality of search queries, each of which includes one or more query terms;

constructing at least one association graph that includes at least a portion of the query terms as vertices;

presenting, to a second user different from the first users, an interactive advertisement that advertises the first website, when the second user visits a second website different from the first website; and

using the association graph, configuring search functionality of the interactive advertisement for searching the first website.

For some applications, the at least one association graph includes at least one first association graph, the search queries include first search queries, and the query terms include first query terms, and configuring the search functionality includes:

receiving a plurality of second search queries from the second user, each of which includes one or more second query terms;

constructing a second association graph that includes at least a portion of the second query terms as vertices; and

configuring the search functionality responsively to a comparison of the second association graph and the at least one first association graph.

For some applications, the search functionality includes first search functionality, the interactive advertisement includes a first interactive advertisement having the first search functionality, and receiving the plurality of second search queries includes:

presenting, to the second user, one or more second interactive advertisements, which include second search functionality for searching websites other than respective websites on which the interactive advertisements are presented; and

receiving at least a portion of the second search queries from the second user via the second search functionality.

For some applications, configuring the search functionality includes populating a search field of the search functionality with a default search query determined using the association graph. For example, populating the search field may include including in the default search query terms that dominate searches performed on the first website by the first users.

For some applications, configuring the search functionality includes presenting search refinement options selected using the association graph.

For some applications, the search queries include first search queries, and presenting the advertisement includes:

presenting a range of levels of personalization of search results, including a personalized level, a global level that is not personalized, and a community level between the personalized level and the global level;

receiving from the second user an indication of a desired one of the levels;

receiving from the second user a second search query;

generating a search result listing responsively to the second search query;

ranking at least a portion of the search result listing at least in part responsively to the indication; and

presenting at least a portion of the ranked search result listing to the second user in the advertisement.

For some applications, the search queries include first search queries, and presenting the advertisement includes:

receiving from the second user a second search query;

receiving from the second user an indication of a desired level of personalization of refinement options for the second search query;

responsively to the second search query, generating a set of one or more refinement terms at least in part responsively to the indication;

presenting the set of refinement terms to the second user;

responsively to a selection of at least one of the refinement terms by the second user, adding the selected at least one refinement term to the second search query to generate a third search query; and

presenting search results to the second user in the advertisement responsively to the third search query.

There is additionally provided, in accordance with an embodiment of the present invention, apparatus including:

an interface; and

a processor, which is configured to present, via the interface, to first users that visit one or more first websites, an interactive advertisement that includes search functionality for searching a second website different from the first websites; receive from the first users, via a search field of the search functionality, respective first search queries, each of which consists of one or more first query terms; present to the first users respective first search result listings, each of which includes first search results associated with respective search result documents of the second website; construct an advertisement profile for the advertisement that represents interactions between the first users and a plurality of the first search results; present the advertisement to a second user that visits one of the first websites; and configure the search functionality responsively to the advertisement profile.

There is yet additionally provided, in accordance with an embodiment of the present invention, apparatus including:

an interface; and

a processor, which is configured to present, via the interface, an interactive advertisement to a plurality of first users that visit one or more first websites, which advertisement includes a search field for searching a second website different from the first websites; during searches performed by the first users, receive from the first users respective search queries via the search field; present to the first users respective search result listings; construct an advertisement profile for the advertisement that represents interactions between the first users and the advertisement during the searches; analyze content of at least one webpage of a third website different from the second website, to generate a set of one or more webpage keywords characterizing the webpage; determine a level of relevance of the interactive advertisement to the webpage by performing a comparison of the webpage keywords and the advertisement profile; and present the advertisement to a second user that visits the third website, responsively to the level of relevance.

There is also provided, in accordance with an embodiment of the present invention, apparatus including:

an interface configured to be coupled to a network; and

a processor, which is configured to receive, over the network via the interface, a request from a user to access a webpage of a first website; examine a referrer URL to determine whether the user was referred to the webpage from a search engine; upon finding that the user was referred, extract from the referrer URL a first search query entered by the user into the search engine; present to the user an interactive advertisement that includes a search field for searching a second website different from the first website; populate the search field with a default second search query determined responsively to the first search query; upon receiving an indication from the user to perform a search using the default second search query, generate search results by performing a search of the second website using the default second search query; and present at least a portion of the search results to the user in the interactive advertisement.

There is further provided, in accordance with an embodiment of the present invention, apparatus including:

an interface; and

a processor, which is configured to present, via the interface, to a user visiting a first website, an interactive advertisement that includes a search field for searching a second website different from the first website; receive a search query from the user via the search field; generate a first set of search results by performing a search of the second website using the search query; upon finding that a relevancy of the first set of search results to the search query does not exceed a threshold relevancy, generate a second set of search results by performing, using the search query, a search of a third website different from the first and second websites; and present at least a portion of the second set of search results in the interactive advertisement.

There is still further provided, in accordance with an embodiment of the present invention, apparatus including:

an interface; and

a processor, which is configured to observe, via the interface, first interactions of a plurality of first users with a first website; responsively to the first interactions, define a plurality of communities, each of which includes some of the first users; generate respective community profiles for the communities; present, to a second user different from the first users, via the interface, an interactive advertisement that advertises the first website, when the second user visits a second website different from the first website; receive a profile of the second user; and, upon finding that the profile of the second user correlates with one of the community profiles, configure an interactive element of the interactive advertisement using the community profile.

There is additionally provided, in accordance with an embodiment of the present invention, apparatus including:

an interface configured to be coupled to a network; and

a processor, which is configured to generate a profile for an internet advertisement; receive, over the network via the interface, at least one request from at least one first user to access a webpage; examine a referrer URL of the request to determine whether the first user was referred to the webpage from a search engine; upon finding that the first user was referred, extract from the referrer URL a search query entered by the first user into the search engine; generate a set of one or more webpage keywords characterizing the webpage, which set includes one or more terms of the search query extracted from the referrer URL; determine a level of relevance of the advertisement to the webpage by performing a comparison of the webpage keywords and the advertisement profile; and present the advertisement to a second user that visits the webpage, responsively to the level of relevance.

There is yet additionally provided, in accordance with an embodiment of the present invention, apparatus including:

an interface; and

a processor, which is configured to present to a user, via the interface, an advertisement that advertises a first website, when the user visits a second website different from the first website, the advertisement including at least one navigation element directed to the first website; receive a profile of the user; and, upon the user activating the navigation element, select one of a plurality of webpages of the first website responsively to the profile of the user, and present the selected webpage to the user.

There is also provided, in accordance with an embodiment of the present invention, apparatus including:

an interface; and

a processor, which is configured to receive, via the interface, from first users performing searches on a first website, a plurality of search queries, each of which includes one or more query terms; construct at least one association graph that includes at least a portion of the query terms as vertices; present, via the interface, to a second user different from the first users, an interactive advertisement that advertises the first website, when the second user visits a second website different from the first website; and configure, using the association graph, search functionality of the interactive advertisement for searching the first website.

There is further provided, in accordance with an embodiment of the present invention, a computer software product including a tangible computer-readable medium in which program instructions are stored, which instructions, when read by a computer, cause the computer to present to first users that visit one or more first websites, an interactive advertisement that includes search functionality for searching a second website different from the first websites; receive from the first users, via a search field of the search functionality, respective first search queries, each of which consists of one or more first query terms; present to the first users respective first search result listings, each of which includes first search results associated with respective search result documents of the second website; construct an advertisement profile for the advertisement that represents interactions between the first users and a plurality of the first search results; present the advertisement to a second user that visits one of the first websites; and configure the search functionality responsively to the advertisement profile.

There is still further provided, in accordance with an embodiment of the present invention, a computer software product including a tangible computer-readable medium in which program instructions are stored, which instructions, when read by a computer, cause the computer to present an interactive advertisement to a plurality of first users that visit one or more first websites, which advertisement includes a search field for searching a second website different from the first websites; during searches performed by the first users, receive from the first users respective search queries via the search field; present to the first users respective search result listings; construct an advertisement profile for the advertisement that represents interactions between the first users and the advertisement during the searches; analyze content of at least one webpage of a third website different from the second website, to generate a set of one or more webpage keywords characterizing the webpage; determine a level of relevance of the interactive advertisement to the webpage by performing a comparison of the webpage keywords and the advertisement profile; and present the advertisement to a second user that visits the third website, responsively to the level of relevance.

There is additionally provided, in accordance with an embodiment of the present invention, a computer software product including a tangible computer-readable medium in which program instructions are stored, which instructions, when read by a computer, cause the computer to receive, over the network, a request from a user to access a webpage of a first website; examine a referrer URL to determine whether the user was referred to the webpage from a search engine; upon finding that the user was referred, extract from the referrer URL a first search query entered by the user into the search engine; present to the user an interactive advertisement that includes a search field for searching a second website different from the first website; populate the search field with a default second search query determined responsively to the first search query; upon receiving an indication from the user to perform a search using the default second search query, generate search results by performing a search of the second website using the default second search query; and present at least a portion of the search results to the user in the interactive advertisement.

There is yet additionally provided, in accordance with an embodiment of the present invention, a computer software product including a tangible computer-readable medium in which program instructions are stored, which instructions, when read by a computer, cause the computer to present to a user visiting a first website, an interactive advertisement that includes a search field for searching a second website different from the first website; receive a search query from the user via the search field; generate a first set of search results by performing a search of the second website using the search query; upon finding that a relevancy of the first set of search results to the search query does not exceed a threshold relevancy, generate a second set of search results by performing, using the search query, a search of a third website different from the first and second websites; and present at least a portion of the second set of search results in the interactive advertisement.

There is also provided, in accordance with an embodiment of the present invention, a computer software product including a tangible computer-readable medium in which program instructions are stored, which instructions, when read by a computer, cause the computer to observe first interactions of a plurality of first users with a first website; responsively to the first interactions, define a plurality of communities, each of which includes some of the first users; generate respective community profiles for the communities; present, to a second user different from the first users, an interactive advertisement that advertises the first website, when the second user visits a second website different from the first website; generate receive a profile of the second user; and, upon finding that the profile of the second user correlates with one of the community profiles, configure an interactive element of the interactive advertisement using the community profile.

There is further provided, in accordance with an embodiment of the present invention, a computer software product including a tangible computer-readable medium in which program instructions are stored, which instructions, when read by a computer, cause the computer to generate a profile for an internet advertisement; receive, over the network, at least one request from at least one first user to access a webpage; examine a referrer URL of the request to determine whether the first user was referred to the webpage from a search engine; upon finding that the first user was referred, extract from the referrer URL a search query entered by the first user into the search engine; generate a set of one or more webpage keywords characterizing the webpage, which set includes one or more terms of the search query extracted from the referrer URL; determine a level of relevance of the advertisement to the webpage by performing a comparison of the webpage keywords and the advertisement profile; and present the advertisement to a second user that visits the webpage, responsively to the level of relevance.

There is still further provided, in accordance with an embodiment of the present invention, a computer software product including a tangible computer-readable medium in which program instructions are stored, which instructions, when read by a computer, cause the computer to present to a user an advertisement that advertises a first website, when the user visits a second website different from the first website, the advertisement including at least one navigation element directed to the first website; receive a profile of the user; and, upon the user activating the navigation element, select one of a plurality of webpages of the first website responsively to the profile of the user, and present the selected webpage to the user.

There is additionally provided, in accordance with an embodiment of the present invention, a computer software product including a tangible computer-readable medium in which program instructions are stored, which instructions, when read by a computer, cause the computer to receive, from first users performing searches on a first website, a plurality of search queries, each of which includes one or more query terms; construct at least one association graph that includes at least a portion of the query terms as vertices; present, to a second user different from the first users, an interactive advertisement that advertises the first website, when the second user visits a second website different from the first website; and configure, using the association graph, search functionality of the interactive advertisement for searching the first website.

The present invention will be more fully understood from the following detailed description of embodiments thereof, taken together with the drawings, in which:

### BRIEF DESCRIPTION OF THE DRAWINGS

FIG. 1 is a schematic, pictorial illustration of a network environment including an advertisement system, in accordance with an embodiment of the present invention;

FIGS. 2A-B are schematic illustrations of exemplary screenshots of a browser displaying a webpage that includes an interactive advertisement, in accordance with an embodiment of the present invention;

FIG. 3 shows an exemplary association graph, in accordance with an embodiment of the present invention;

FIG. 4 shows two subgraphs of the association graph of FIG. 3, in accordance with an embodiment of the present invention;

FIG. 5 shows an exemplary site association graph (SAG), in accordance with an embodiment of the present invention;

FIG. 6 is a schematic illustration of an exemplary screenshot of a browser, in accordance with an embodiment of the present invention; and

FIGS. 7A-C show exemplary association graphs, in accordance with respective embodiments of the present invention.

### DETAILED DESCRIPTION OF EMBODIMENTS

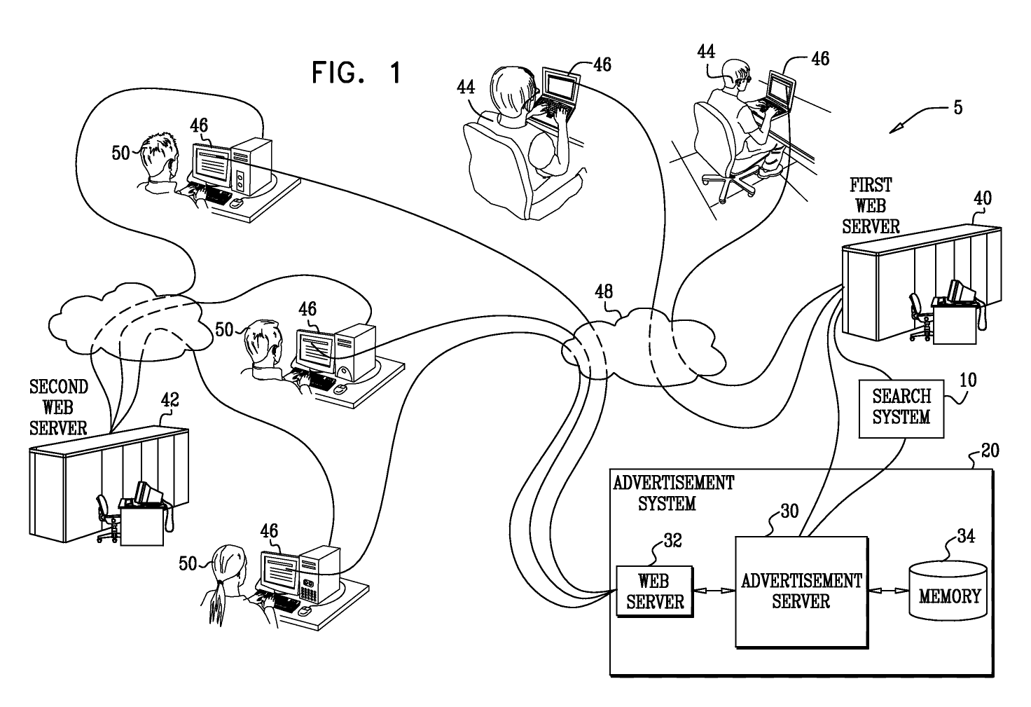

FIG. 1 is a schematic, pictorial illustration of a network environment 5 including an advertisement system 20, in accordance with an embodiment of the present invention. Advertisement system 20 comprises an advertisement server 30, an interface, such as a web server 32, and a memory 34. Network environment 5 further includes at least one first web server 40, and at least one second web server 42. First and second web servers 40 and 42 are typically operated by different entities. A plurality of first users 44 use respective workstations 46, such as a personal computers, to remotely access first web server 40 via a wide-area network (WAN) 48, such as the Internet. First web server typically offers search functionality to first users 44. Such search functionality is provided by at least one search system 10. Although search system 10 is shown in FIG. 1 as a separate server, it may be incorporated into first web server 40 or advertisement system 20. For some applications, search system 10 uses techniques described in International Patent Application PCT/US07/67103, which published as PCT Publication WO 07/124430, and which is assigned to the assignee of the present application and is incorporated herein by reference, and/or in the other applications incorporated by reference hereinbelow.

Typically, advertisement system 20 and search system 10 comprise one or more respective standard computer servers with appropriate memory, communication interfaces and software for carrying out the functions prescribed by the present invention. This software may be downloaded to the systems in electronic form over a network, for example, or it may alternatively be supplied on tangible media, such as CD-ROM. Memory 34 comprises a non-volatile memory, such as one or more hard disk drives, and/or a volatile memory, such as random-access memory (RAM).

A plurality of second users 50 use respective workstations 46 to remotely access second web server 42 via WAN 48. Alternatively, one or more of first or second users 44 or 50 access first web server 40 or second web server 42, respectively, via a local area network (LAN), or both a LAN and a WAN. Typically, a web browser 36 running on each workstation 46 communicates with first or second web server 40 or 42. Each of workstations 46 comprises a central processing unit (CPU), system memory, a non-volatile memory such as a hard disk drive, a display, input and output means such as a keyboard and a mouse, and a network interface card (NIC). Alternatively, instead of workstations, the users use other devices, such as portable and/or wireless devices, to access the servers.

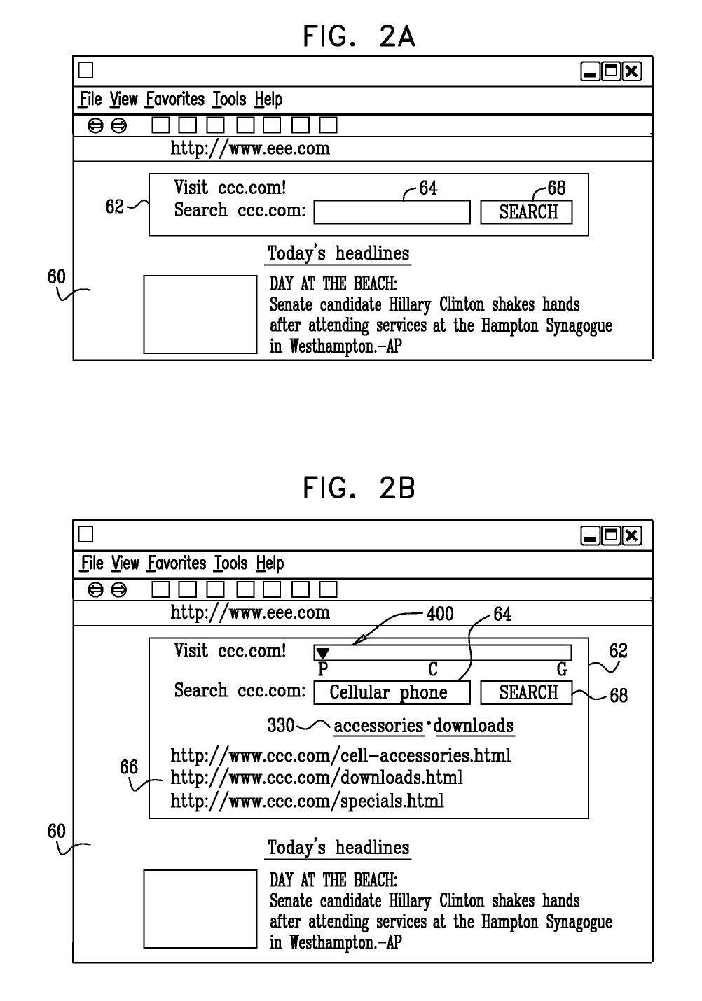

Reference is made to FIGS. 2A-B, which are schematic illustrations of exemplary screenshots of a browser displaying a webpage 60 that includes an interactive advertisement 62, in accordance with an embodiment of the present invention. Second web server 42 serves webpage 60 (in this example, www.eee.com). Advertisement system 20 serves interactive advertisement 62, which advertises a website served by first web server 40 (in this example, www.ccc.com). Interactive advertisement 62 typically has search functionality for enabling searching of the content of the advertised website, and presenting, in the interactive advertisement, search results or other content related to the search. “Presenting” content, as used in the present application, including the claims, is effectively accomplished by downloading an object (such as hyptertext or code) to a browser or other application running on a computer or other device of the user, which executes the object in order to present the content to the user of the browser.

For some applications, internet advertisement 62 comprises a banner ad, as shown in the figures, while for other applications, the internet advertisement comprises another type of advertisement, such as a widget.

The search functionality of interactive advertisement 62 typically includes a search field 64, into which a second user 50 may enter a search query. As shown in FIG. 2B, when the second user enters a search query into the search field, search results 66 are displayed in the interactive advertisement. Search results 66 typically include links to webpages of the advertised website (served by first web server 40), snippets of the webpages, and/or other content (typically associated with the advertised website), such as Flash or video. For some applications, the search results are not displayed until the second user clicks on a search button 68, while for other applications, the search results are displayed and modified in real time as the user enters and modifies the search query. Optionally, the search functionality includes the presentation of refinement options 110, which are suggested in part responsively to the search query. Upon selection by the user, one of the refinement options is added to the search query, or replaces one of the terms of the search query. For some applications, techniques for determining, presenting, and configuring refinement options are used that are described in International Patent Application PCT/US07/67103, U.S. patent application Ser. No. 11/846,213, and/or the other patent applications incorporated by reference hereinbelow, mutatis mutandis.

Advertisement system 20 configures the search functionality or other aspects of interactive advertisement 62 responsively to observed interactions of first users 44 with first web server 40 (the advertised website) and/or search system 10. For example, the advertising system may populate search field 64 of the advertisement with a default search query responsively to the observed interactions. Alternatively or additionally, system 20 configures the search functionality or other aspects of interactive advertisement 62 responsively to a profile of the second user viewing the advertisement, and/or a community of users to which the second user belongs.

In an embodiment of the present invention, first users 44 perform searches of the advertised website (served by first web server 40) using search queries comprising one or more query terms. Search system 10 constructs a site association graph (SAG) that includes at least a portion of the query terms as vertices. Advertisement system 20 uses the SAG to configure the search functionality of the interactive advertisement.

### Association Graph Overview

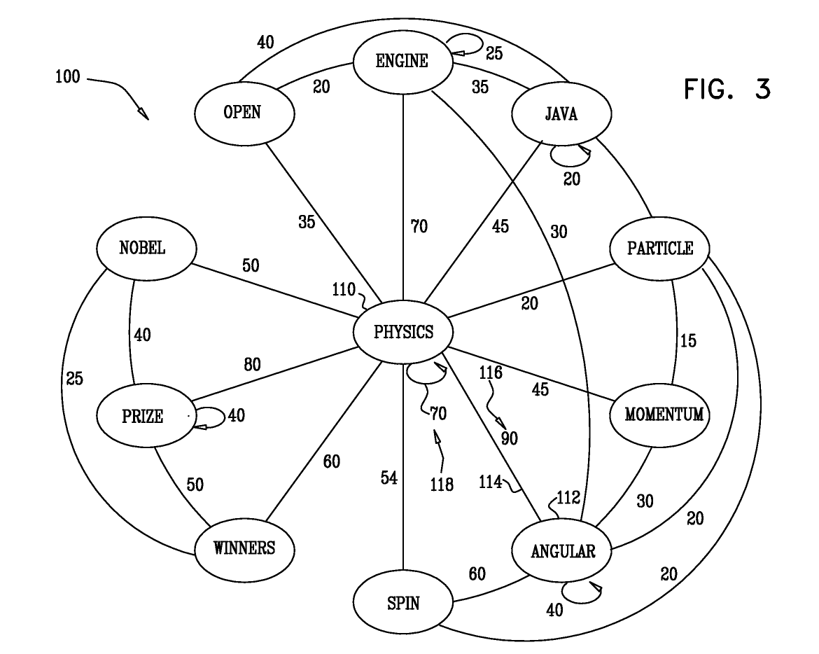

Reference is made to FIG. 3, which shows an exemplary association graph 100, in accordance with an embodiment of the present invention. Many of the techniques of embodiments of the present invention utilize association graphs such as illustrated by association graph 100. Although exemplary association graph 100 includes only limited degrees of association, search system 10 and advertisement system 20 often develop larger and more complex association graphs, which may include degrees of association greater than two.

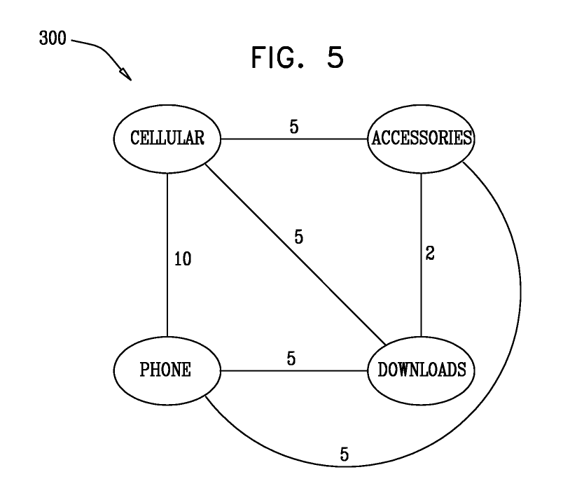

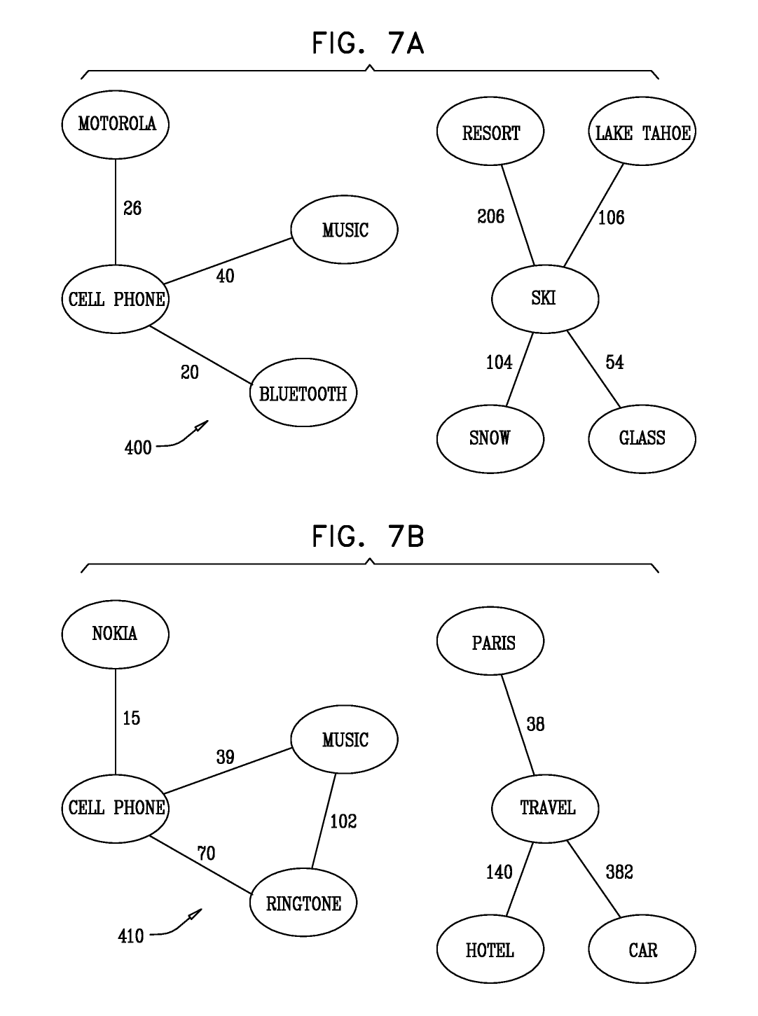

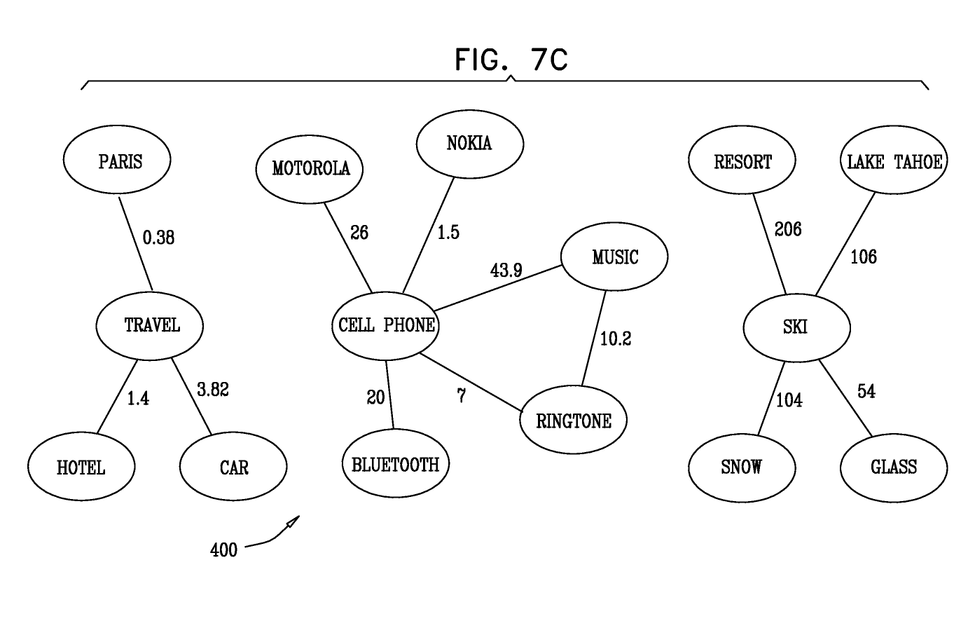

Search system 10 and advertisement system 20 use association graphs to cluster users, their search interests and patterns, and information regarding search result documents in respective clusters. Search system 10 and/or advertisement system 20 create and maintain one or more of the following association graphs:
a personal association graph (PAG), which is created for each first user 44, for example using techniques described in above-mentioned International Patent Application PCT/US07/67103 with reference to FIGS. 7-9. In general, each PAG represents the interactions of a plurality documents with a single user during one or more searches conducted during one or more search sessions;
a session association graph, which is created for each search session for each first user 44. In general, each SAG represents the interactions of one or more documents with a single user during one or more searches conducted by the user during a single search session;
a hotspot association graph (generally referred to herein simply as a “hotspot”), one or more of which are extracted from each PAG, as described in above-mentioned International Patent Application PCT/US07/67103 with reference to FIGS. 10-11. In general, a hotspot includes a portion of a PAG that represents an area of particular importance to the user of the PAG. For some applications, hotspots are alternatively or additionally extracted from each session association graph, using the techniques for such extraction from a PAG;
a topic association graph (TAG), which is created for each identified topic, as described in above-mentioned International Patent Application PCT/US07/67103 with reference to FIGS. 12-13. In general, a TAG represents the interactions of a plurality of searches conducted by a plurality users within a single topic;
a document association graph (DAG), which is created for each document (typically a webpage of the advertised website, represented by a unique URL) selected from search results by any first user 44, as described in above-mentioned International Patent Application PCT/US07/67103 with reference to FIGS. 7-8. In general, a DAG represents the interactions with a single document of a plurality of searches conducted by a plurality of users;
a site association graph (SAG), which is created for each website (typically represented by a collection of webpages sharing a common domain name), as described hereinbelow with reference to FIG. 5. In general, a SAG represents the interactions with all of the webpages of a single website of a plurality of searches conducted by a plurality of users;
a global association graph (GAG), which represents a merger of all or a large portion of the PAGs or their hotspots, as described hereinbelow in above-mentioned International Patent Application PCT/US07/67103 with reference to FIGS. 7-8. In general, a GAG represents the interactions of a plurality of users with all or a large portion of the document set of a particular deployment of search system 10; and
a group association graph (GRAG), which represents a merger of a plurality of correlated PAGs or their hotspots, as described hereinbelow.

Each association graph comprises one or more vertices, each of which is linked to one or more other vertices by respective edges. Furthermore, a vertex may be linked to itself by an edge in some instances, as described hereinbelow. In the art, and in the applications assigned to the assignee of the present application that are incorporated hereinbelow by reference, “vertices” are sometimes referred to as “nodes,” and “edges” are sometimes referred to as “arcs” or “links.”

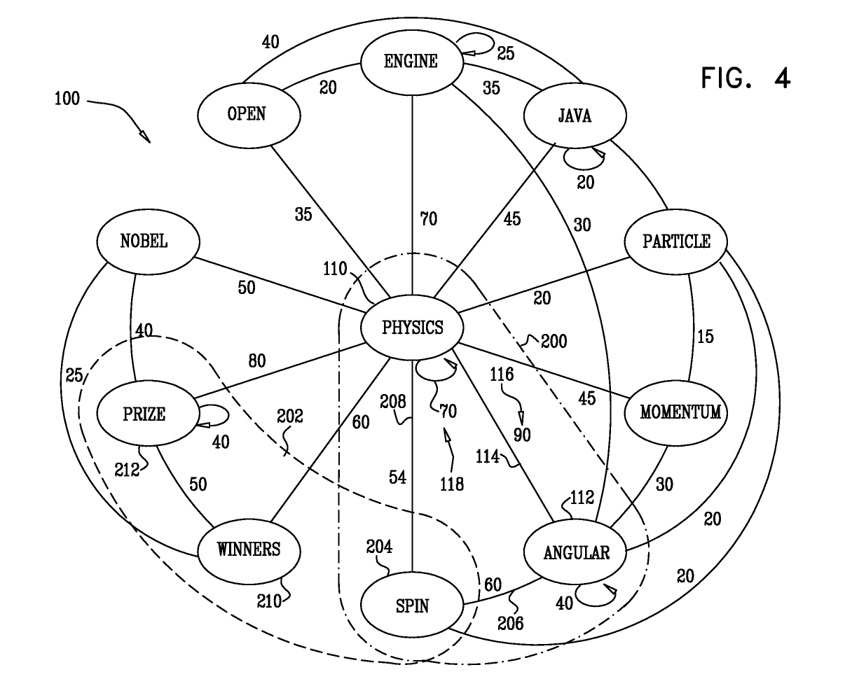

An association graph can be represented visually as a plurality of vertices linked (i.e., connected) by lines representing edges, as shown in FIG. 3, or as an adjacency matrix, as described with reference to FIG. 4 in above-mentioned International Patent Application PCT/US07/67103. Search system 10 stores association graphs using one or more data structures. The phrase “association graph,” as used herein, including in the claims, includes any data structure that conceptually includes vertices linked by edges, regardless of the nomenclature used to describe the data structure, or how it may be represented, stored, structured, and/or manipulated in memory and/or another storage medium. For some applications, more than one edge links some pairs of vertices. For some applications, the association graph comprises a hypergraph, i.e., a single edge connects more than two vertices. For some applications, the association graph is not directed, i.e., the edges do not include a direction, while for other applications, the association graph is at least partly directed, i.e., at least a portion of the edges include a direction. For some applications, by linking a plurality of directed edges, the search system develops multi-vertex paths of connectivity among vertices.

Each vertex of an associate graph includes a single term, which comprises one or more keywords. Typically, when a term includes a plurality of keywords, the keywords are order-sensitive. In exemplary association graph 100 shown in FIG. 3, a first vertex 110 includes the single-keyword term “physics,” while a second vertex 112 includes the single-keyword term “angular.” Each edge has a score that represents the strength of the association of the vertices linked by the edge. For example, an edge 114 that links vertices 110 and 112 has a score 116 equal to 90. As mentioned above, a vertex may be linked to itself; for example, vertex 110 has a self-referential score 118 equal to 70. Association scores are typically, but not necessarily, symmetric, i.e., are not directed.

For some applications, to store association graph 100 in memory 24, search system 10 uses the exemplary data structure described with reference to FIG. 5 of above-mentioned International Patent Application PCT/US07/67103.

For clarity of presentation, in the present application, including in the claims, a vertex of an association graph including a term is sometimes referred to simply as the term itself. For example, it may be stated that a first term of an association graph is linked to a second term of the association graph, rather than more verbosely stating that a first vertex of an association graph containing a first term is linked to a second vertex of the association graph containing a second term.

### Association Scores

Reference is made to FIG. 4, which shows two subgraphs of association graph 100 of FIG. 3, in accordance with an embodiment of the present invention. Numerous embodiments of the present invention utilize an association score that represents the strength of association among one or more vertices of a subgraph of an association graph. The association score typically takes into consideration both the scores of the edges within the subgraph, and a measure of balance among the scores. Subgraphs having greater balance are considered to have a greater strength of association, ceteris paribus.

In an embodiment of the present invention, the association score of a subgraph of an association graph is (a) positively related to a measure of an average of the edge scores linking the vertices within the subgraph, and (b) inversely related to a measure of variability of the edge scores. For example, the association score of the subgraph may be equal to the quotient of (a) the measure of the average, and (b) the measure of the variability. Optionally, the divisor (b) equals the sum of the measure of the variability and a constant, such as 1. For example, the measure of the average may be an arithmetic mean, a geometric mean, a median, or a mode, and the measure of variability may be a standard deviation or a variance.

For some applications, search system 10 uses the following equation to calculate the association score of a subgraph:

$$association\_score = \frac{average\_edge \_score}{( 1 + \sqrt{var ( edge\_score )} )} \qquad ( Equation 1 )$$

In FIG. 4, exemplary association graph 100 includes first and second subgraphs 200 and 202. Subgraph 200 includes vertices 110 (“physics”), 112 (“angular”), and 204 (“spin”), linked by edges 114, 206, and 208. Applying Equation 1, the association score of subgraph 200 is calculated as:

$$\begin{matrix}\frac{( 90 + 60 + 54 ) / 3}{1 + sqrt [ \begin{matrix}( 90 - 68 ) \hat{} 2 + ( 60 - 68 ) \hat{} \\ 2 + ( 54 - 68 ) \hat{} 2\end{matrix} ]} = 68 / [ 1 + sqrt ( 248 ) ] \\ = 4.06\end{matrix}$$

If, for example, score 116 of edge 114 were 57 instead of 90, the association score would be 16.52. This higher score reflects the greater balance of subgraph 200, which outweighs the lower average than in the earlier example.

For some applications, the edge scores of the subgraph are normalized before applying Equation 1, typically by dividing each of the edge scores by a normalization factor equal to the greatest edge score in the subgraph, such that each edge score receives a normalized value of between 0 and 1. The result returned by Equation 1 is typically multiplied by the normalization factor. This normalization technique is reflected by the following equation:

$$association\_score = normalization\_factor \cdot \frac{average\_normalized \_edge \_score}{( 1 + \sqrt{var ( edge\_score )} )} \qquad ( Equation 2 )$$

Application of Equation 2 to the exemplary values given above yields the following calculation of the association score of subgraph 200:

$$\begin{matrix}90 \cdot \frac{( 90 / 90 + 60 / 90 + 54 / 90 ) / 3}{\begin{matrix}1 + sqrt [ ( 1 - 0.756 ) \hat{} 2 + ( 0.667 - \\ 0.756 ) \hat{} 2 + ( 0.6 - 0.756 ) \hat{} 2 ]\end{matrix}} = 90 \cdot 0.756 / [ 1 + sqrt ( 0.175 ) ] \\ = 57.9\end{matrix}$$

Typically, the association score of a subgraph is defined to be zero if not all vertices of the subgraph are linked to all other vertices of the subgraph. The association score of subgraph 202 is thus zero, because vertex 204 (“spin”) is linked to neither a vertex 210 (“winners”) nor a vertex 212 (“prize”) of the subgraph. Alternatively, for some applications, this condition is less rigid. For example, the association score may be non-zero if all of the vertices of the subgraph are linked to at least one other vertex of the subgraph, but not necessarily all of the other vertices of the subgraph.

### Site Association Graphs (SAGs)

Reference is made to FIG. 5, which shows an exemplary site association graph (SAG) 300, in accordance with an embodiment of the present invention. As mentioned above, first users 44 of the advertised website perform searches of the advertised website using search queries comprising one or more query terms. The results of these searches include webpages of the website. Based on (a) the query terms, (b) search result snippets presented, and (c) webpages selected and/or not selected for presentation, search system 10 constructs SAG 300, which includes at least a portion of the query terms as vertices.

To construct SAG 300, search system 10 collects and analyzes interactions between first users 44 and first web server 40. For some applications, the system uses techniques described in above-mentioned International Patent Application PCT/US07/67103, such as techniques performed by background processor 50 and feedback processor 302 thereof, and/or techniques described with reference to FIGS. 7-9 thereof. Search system 10 analyzes search interactions of first users 44, an updates the respective users' PAGs and the respective DAGs of the webpages selected from the search results, using techniques described in above-mentioned International Patent Application PCT/US07/67103, such as with reference to FIGS. 7-9.

To construct and maintain SAG 300, search system 10 generally adds the same vertices, edge scores, and/or edge score updates generated from a given interaction event to SAG 300 as are added to the DAG of the selected webpage. Typically, SAG updates include the same addition of terms from search results added to the DAGs and/or incrementing of scores of such search results already included in the association graph.

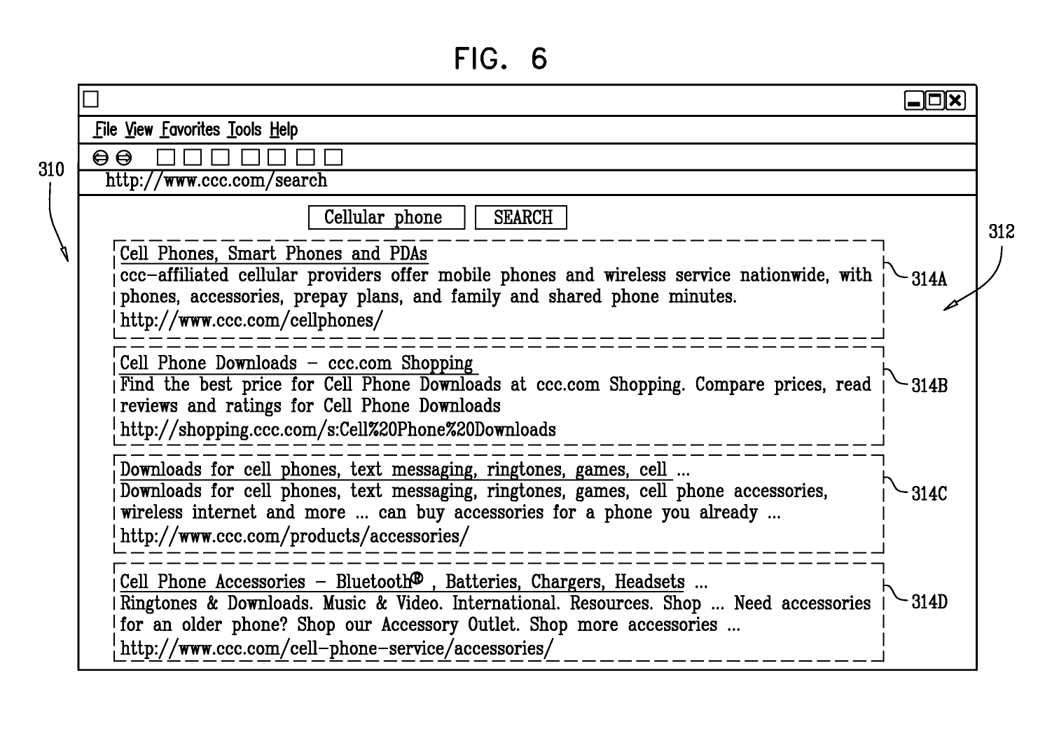

Reference is made to FIG. 6, which is a schematic illustration of an exemplary screenshot 310 of a browser of one of first users 44, in accordance with an embodiment of the present invention. In this example, assume that the first user performs a search of the advertised website (having the exemplary domain name www.ccc.com, as described hereinabove with reference to FIGS. 2A-B), with the search query “cellular phone.” This search is typically performed by the first user when visiting the first website. In response to the query, search system 10 generates and first web server 40 presents exemplary search results 312, which typically comprise snippets 314A, 314B, 314C, and 314D, from each of the documents in the search results. Each snippet includes one or more of the keywords of the query, and the URL of the document.

For some applications, the search system uses techniques described in above-mentioned International Patent Application PCT/US07/67103 (such as regarding internal search processor 62) to rank and order the results based on characteristics of the particular user, one or more communities to which the user belongs, and/or global characteristics of all of the users of the particular deployment of search system 10. For some applications, the first user selects a desired preference regarding which of these characteristics should be used for ranking, such as by using a sliding pointer, or other means that will be evident to those skilled in the art who have read the present application. Such preferences typically include one or more of a personal-based preference, a community-based preference, and a global-based preference, such as described in the international application.

Continuing the example, the first user selects the third snippet, snippet 314C. First web server 40 presents the selected webpage to the first user, and the first user interacts with the selected webpage sufficiently to warrant updating the relevant association graphs (for example, sufficient interaction may be determined by evaluating time spent viewing the selected webpage, a purchase action, or any other significant activity on or with respect to the selected webpage).

Search system 10 analyzes the snippets, and selects the terms “accessories” and “downloads” to be added to the one or more association graphs, including SAG 300, and, typically, the user's PAG and the selected webpage's DAG. Such selection and addition are typically performed using techniques described in above-mentioned International Patent Application PCT/US07/67103, such as with reference to FIGS. 7-9.

Reference is again made to FIG. 5, which shows SAG 300 after the terms “accessories” and “downloads” have been added to the SAG in association with the query terms “cellular” and “phone.” The search system typically scores the edges between the vertices using techniques described in above-mentioned International Patent Application PCT/US07/67103, such as with reference to FIGS. 7-9. The exemplary edge scores shown in FIG. 5 reflect the greatest association between the query terms provided by the user, less association between the terms extracted from the selected snippet because of the uncertainty regarding whether the correct terms have been extracted from the snippets, and even less association between the terms “accessories” and “downloads” because this association is evident in only a single one of the snippets (snippet 314C).

As numerous first users 44 perform searches of the advertised website and interact with the search results, SAG 300 grows and evolves to reflect the collective interests of the users with respect to the advertised website. DAGs for the individual webpages of the advertised website also develop.

Advertisement system 20 utilizes the information reflected in SAG 300 to configure the search functionality for the second users 46 who view interactive advertisement 62 on webpage 60 served by second web server 42. Typically, any given second user 46 viewing interactive advertisement 62 for the first time has not yet visited the advertised website served by first web server 40.

Continuing the example begun above with reference to FIGS. 5 and 6, reference is again made to FIG. 2B. One of second users 46 enters the search query “cellular phone” into search field 64. Advertisement system 20 determines which search results to display and/or the ranking of the search results using SAG 300, typically using techniques described in above-mentioned International Patent Application PCT/US07/67103, and/or the other patent applications incorporated herein by reference hereinbelow. As can be seen in exemplary search results 66 in FIG. 2B, the advertisement system has highly ranked search results containing the terms “download” or “accessories,” responsively to the associations of these terms with the terms of the search query, as reflected in SAG 300.

For some applications, advertisement system 20 includes the presentation of refinement options 330 in the search functionality of interactive advertisement 62. The advertisement system uses the associations reflected in SAG 300 to select which refinement options are most likely to be of interest to the second user, typically using techniques described in above-mentioned International Patent Application PCT/US07/67103 (e.g., with reference FIGS. 16-19), and/or the other patent applications incorporated herein by reference hereinbelow. In the present example, the terms “accessories” and “downloads” are presented because of these terms' associations with the search terms in SAG 300. Selection of one of these refinement options by the second user causes the selected refinement option to be added to the query.

For some applications, the system selects which refinement options to present responsively to a user-selected level of personalization ranging from a personalized level, a global level that is not personalized, and a community level between the personalized level and the global level, such as described in the international application. For example, the system may use techniques described hereinbelow with reference to FIG. 2B for allowing the user to select the level of personalization. For some applications, system 20 integrates the search results with the refinement options, using the techniques described with reference to FIG. 20 of the international application. For some applications, the system is configured to present suggested replacements of one or more terms of the search query with substitute terms that may better express the intended search interest of second user, such as using techniques described in U.S. patent application Ser. No. 11/846,213, e.g., with reference to FIGS. 21-23. Replacement of a search term with a substitute term often results in the broadening of the search query.

In an embodiment of the present invention, advertisement system 20 configures the search functionality of interactive advertisement 62 by comparing a profile of one of second users 50 with SAG 300. Typically, the profile comprises an association graph associated with the second user, such as a personal association graph (PAG) or a session association graph. Alternatively, the profile includes other information about the user determined explicitly or implicitly, for example derived from search logs, browsing history, and/or recent session patterns of the user.

For some applications, such configuring of the search functionality includes configuring the selection and/or ranking of search results 66. Techniques may be used that are described in above-mentioned International Patent Application PCT/US07/67103, such as with reference to FIG. 15. Alternatively or additionally, such configuring includes configuring the selection of refinement options 330. Techniques may be used that are described in above-mentioned International Patent Application PCT/US07/67103, such as with reference to FIGS. 16-20.

Advertisement system 20 constructs the PAG or session association graph for the second user by monitoring interactions of the second user during searches conducted by the second user, and including as vertices search terms used by the second user, for example using techniques described in above-mentioned International Patent Application PCT/US07/67103 with reference to FIGS. 7-9. Such searches typically include one or more of the following:
searches conducted by the second user on a general Internet search engine that indexes content of the World Wide Web;
searches conducted by the second user on one or more websites for content of webpages of the websites; and/or
searches conducted by the second user using search functionality of the interactive advertisement in which the second user is performing the current search, and/or using search functionality of one or more other interactive advertisements in which the second user has previously conducted searches.

Alternatively or additionally, the system configures the search functionality responsively to a comparison of SAG 300 with one or more association graphs representing interactions of a community of users to which the second user implicitly belongs, or all or a large portion of users for which search information is available. The system typically performs the former comparisons using one or more topic association graphs (TAGs) associated with the user and/or the search query, and the latter comparisons using a global association graph (GAG), such as described in above-mentioned International Patent Application PCT/US07/67103, e.g., with reference to FIGS. 15-20.

### Referrer URLs

In an embodiment of the present invention, advertisement system 20 examines a referrer URL to determine whether the second user was referred to the webpage from a search engine website. Upon finding that the second user was referred, the system extracts from the referrer URL the terms of a search query entered by the user while at the search engine website. The system configures the search functionality responsively to these search terms.

For some applications, the system determines or ranks search results using the terms derived from the referrer URL. For example, the system may use these terms as optional expansion terms for the query, and assign higher rankings to those search result documents or snippets that include the terms. Alternatively or additionally, the system may generate an expanded search query comprising the search query terms plus one or more of the terms extracted from the referrer URL, and use these to generate one or more sets of results that are used for generating and ranking the search results presented to the user, such as described above-mentioned International Patent Application PCT/US07/67103 with reference to FIG. 15.

Alternatively or additionally, the system determines at least a portion of refinement options using the terms derived from the referrer URL, and/or keywords derived from the webpage of the referrer URL, for example using keyword derivation techniques described hereinbelow. For example, the system may determine which refinement options to present to the user by deriving keywords from the current webpage (on which the interactive advertisement is displayed), and validating these current webpage keywords against the search terms derived from the referrer URL and/or the keywords of the referring webpage. The system selects as refinement options those validated keywords having the greatest association with SAG 300 of the advertised website, for example by calculating the association score of each of the validated keywords with the SAG, using calculation techniques described hereinabove or in above-mentioned International Patent Application PCT/US07/67103.

In an embodiment of the present invention, advertisement system 20 configures a non-search element of interactive advertisement 62 responsively to an association graph associated with the second user, such as the second user's PAG or session association graph, or an association graph associated with one or more communities to which the user second belongs, such as one or more TAGs.

### Default Search Queries

Reference is again made to FIG. 2A. In an embodiment of the present invention, advertising system 20 configures the search functionality by populating search field 64 with a default search query determined using SAG 300, an association graph associated with the second user (e.g., a PAG, session association graph, or one or more TAGs), or a combination of SAG 300 and an association graph associated with the second user. For example, the system may include in the default search query terms that dominate searches performed on the advertised website by first users 44. For example, if no profile of the user or the user's community is available to the system, the default search query may comprise the terms of the strongest hotspot of SAG 300. The hotspot may be derived, for example, using techniques described in above-mentioned International Patent Application PCT/US07/67103 with reference to FIGS. 10-11, mutates mutandis. If a profile for the user or the user's community is available, the default search query may comprise the terms for which there is a greatest correlation between SAG 300 and the profile, e.g., the user's PAG, the user's session association graph, and/or one or more TAGs associated with the user. Alternatively or additionally, the default search query may comprise the terms for which there is a greatest correlation between SAG 300 and search terms extracted from a referrer URL. These techniques aim to generate a default search query that represents a cross between the user's current state of mind and the interests of users who have performed searches on the advertised website.

In an embodiment of the present invention, advertisement system 20 examines a referrer URL to determine whether the second user was referred to the webpage from a search engine website. Upon finding that the second user was referred, the system extracts from the referrer URL the terms of a search query entered by the user while at the search engine website. The system uses one or more of these terms as the default search query.

### Personalization Levels

Reference is again made to FIG. 2B. In an embodiment of the present invention, advertisement system 20 is configured to receive from second user 50 an indication of a desired level of personalization for ranking and/or for selection of refinement options. For example, the second user may indicate the desired level of personalization using a sliding pointer 400, or other means that will be evident to those skilled in the art who have read the present application.

Such preferences typically include one or more of:
a personal-based preference (indicated by the letter “P” in the figure)—advertisement system 20 determines the ranking of search results based at least in part on user-specific information, typically as reflected in a PAG or session association graph of the second user;
a community-based preference (indicated by the letter “C” in the figure)—advertisement system 20 determines the ranking of search results based at least in part on community-specific information, typically as reflected in one or more TAGs associated with the second user and/or the query; and
a global-based preference (indicated by the letter “G” in the figure)—advertisement system 20 determines the ranking of search results based at least in part on information regarding all or a large portion of the users of the particular deployment of advertisement system 20, typically as reflected in a group association graph (GAG).

In an embodiment of the present invention, the second user is able to select a mixture of two or more of the preferences, for example by positioning sliding pointer 400 between two of the preferences. The system ranks the search results based on a combination of the selected preferences, typically weighted by the position of the slider.

### Advertisement Profiles

Reference is made to FIGS. 7A-C, which show association graphs, in accordance with respective embodiments of the present invention. In an embodiment of the present invention, advertisement system 20 constructs an advertisement profile for interactive advertisement 62. The advertisement profile represents interactions between second users 50 who view the advertisement and results of searches performed by the second users in the advertisement. The system uses the profile to customize the search functionality of the advertisement for other second users 50 who subsequently view the advertisement. For some applications, the system ranks search results presented to the subsequent users responsively to the advertisement profile, or to the advertisement profile and a profile of the subsequent user (such as described hereinabove). Alternatively or additionally, the system generates a set of refinement terms including at least one query term searched by the first users and included in the advertisement profile. The query term is selected for inclusion in the set responsively to a level of association in the advertisement profile of the query term with the query terms searched by the second user.

In an embodiment of the present invention, the advertisement profile comprises an advertisement association graph (AAG) that includes at least a portion of the query terms as vertices. FIG. 7A shows an exemplary AAG 400 for an interactive advertisement. Advertisement system 20 constructs the AAG using techniques similar to those described hereinabove for SAG 300 (FIG. 5) and in above-mentioned International Patent Application PCT/US07/67103. In brief, the system adds vertices to and sets edge scores of the AAG responsively to the terms of searches conducted by the second users and the second users' interactions with the search results. For some applications, the system configures the search functionality responsively to both the AAG and an association graph associated with the second user, such as a PAG, a session association graph, and/or one or more TAGs.

In an embodiment of the present invention, advertisement system 20 reflects in the AAG non-search-related interactions between the second user and the advertisement. For example, information regarding the user may be transferred to the AAG when the user clicks on the advertisement. Such information may be reflected in a profile of the user, such as a PAG or session association graph, or a profile of a community to which the user belongs, such as a TAG.

In an embodiment of the present invention, advertisement system 20 examines a referrer URL to determine whether the second user was referred to the webpage from a search engine website. Upon finding that the second user was referred, the system extracts from the referrer URL the terms of a search query entered by the user while at the search engine website. The system adds one or more of these terms to the AAG, and/or increases the scores between these terms if they are already included in the AAG. For some applications, these terms are added to the AAG when the user performs a search on the interactive advertisement, or interacts with the advertisement in some other way, such as clicking on the advertisement. For some applications, these terms are only added to the AAG if another source of terms is not available, such as an association graph associated with the user (e.g., a PAG, a session association graph, or a TAG). Alternatively, these terms are added to the AAG even when another source of terms is available.

For example, assume that FIG. 7B shows an association graph 410 associated with the user (such as a PAG, a session association graph, or a TAG), and that the user enters the search query “travel” in the search field of the interactive advertisement, and selects one of the presented search results. In addition, assume that the user arrived at the webpage including the interactive advertisement by searching the query “cell phone ringtone” and selecting the result comprising the URL of the webpage. As shown in FIG. 7C, the system makes the following changes to AAG 400 (vs. its original state shown in FIG. 7A):
because the query searched in the advertisement includes the term “travel,” the “travel” vertex and the vertices linked thereto of user's association graph 410 (“hotel,” “car,” and “Paris”) are added to AAG 400, along with their edge scores, after damping the scores (in this example, by dividing by 100). Alternatively, the full values of the edges are transferred to AAG 400; and
because the search terms derived from the referrer URL include “cell phone” and “ringtone,” these vertices and the vertices linked thereto of user's association graph 410 (“Nokia,” “music,” and “ringtone”) are added to the cluster of AAG 400 including the “cell phone” vertex, and the edge scores between and among these terms and the “cell phone” vertex are set to or increased by the corresponding edge score in user's association graph 410, after damping the scores (in this example, by dividing by 10). Alternatively, the full values of the edges are transferred to AAG 400.

For some applications, scores of vertices are increased if their terms are included in the keywords extracted from the webpage.

Optionally, if no search terms are available (because the user does not perform a search in the interactive advertisement, and the user does not arrive at the website by performing a search), when the user interacts with the advertisement, one or more terms from one or more hotspots of user's association graph 410 are added to AAG 400, after highly damping the edge scores of these terms. Alternatively or additionally, this may be done if none of the terms of a query entered into the advertisement are included in user's association graph 410.

### Advertisement Targeting

In an embodiment of the present invention, advertisement system 20 analyzes content of webpages of websites on which it may be appropriate to display a particular interactive advertisement. The system generates a set of one or more webpage keywords characterizing each of the webpages. The system determines respective levels of relevance of the interactive advertisement to each of the webpages by performing a comparison of the webpage keywords of the webpage and the advertisement profile, e.g., the AAG. The system determines on which webpages to display the interactive advertisement responsively to the levels of relevance.

For some applications, the system generates the webpage keywords using conventional techniques, e.g., a bag-of-words approach (optionally filtered, e.g., to remove stop words, or words that appear on other related webpages).

Further alternatively or additionally, the system generates the webpage keywords using latent Dirichlet allocation (LDA). The system identifies terms included in the webpage, and distributes these terms over a set of topics, by finding which of the terms are associated with which of the topics. Each webpage is characterized as a distribution over one or more of these topics, by calculating a weight of each of the topics for the webpage. The system uses the highest weighted topics as keywords for the webpage. For some applications, this technique is used in combination with one or more of the other techniques fro generating webpage keywords described herein.

The system alternatively identifies the webpage keywords using techniques known in the art, such as those described in above-mentioned US Patent Application Publication 2004/0059708 to Dean et al., e.g., with reference to FIG. 5 thereof. For some applications, this technique is used in combination with one or more of the other techniques for generating webpage keywords described herein.

Alternatively or additionally, the system extract terms of the URL of the webpage, and uses some or all of these terms as webpage keywords.

Further alternatively, advertisement system 20 generates the webpage keywords by examining referrer URLs of visitors to each webpage, to determine whether the visitors were referred to the webpage from a search engine website. Upon finding that any of the visitors were referred, the system extracts from the referrer URLs the terms of a search query entered by the visitors while at the search engine website. The system uses one or more of these search terms as webpage keywords. For some applications, this technique is used in combination with one or more of the other techniques for generating webpage keywords described herein.

Further alternatively, advertisement system 20 generates the webpage keywords using respective document association graphs (DAGs) of the webpages, which may be generated using techniques described in above-mentioned International Patent Application PCT/US07/67103.

In an embodiment of the present invention, advertisement system 20 determines on which webpages it may be appropriate to display a particular internet advertisement. The system determines respective levels of relevance of the advertisement to each of the webpages by performing a comparison of a document association graph (DAG) of the webpage and an advertisement association graph (AAG) of the advertisement. The system determines on which webpages to display the advertisement responsively to the levels of relevance. Alternatively, the system makes the determination of appropriateness for a website including a plurality of webpages, using a site association graph (SAG) of the website instead of DAGs of the individual webpages.

In an embodiment of the present invention, advertisement system 20 makes a decision regarding which interactive advertisement to present to a user responsively to a comparison of (a) a profile of an internet advertisement and (b) an association graph associated with the user or one or more communities to which the user belongs. For some applications, the association graph comprises a PAG, a session association graph, and/or one or more TAGs), and/or one or more hotspots of the PAG, session association graph, or TAGs, derived, for example, using techniques described in above-mentioned International Patent Application PCT/US07/67103 with reference to FIGS. 10-11. For some applications, the advertisement profile comprises an advertisement association graph (AAG), as described hereinabove.

Reference is again made to FIGS. 2A-B. In an embodiment of the present invention, advertisement system 20 performs a search of the advertised website to generate a first set of search results responsively to a search query entered into search field 64 of interactive advertisement 62. If the system finds that a relevancy of the first set of search results to the search query does not exceed a threshold relevancy, the system generating a second set of search results by performing, using the search query, a search of a third website different from the advertised website and the website on which the advertisement is displayed. The system presents at least a portion of the second set of search results as results 66 in the advertisement.

In an embodiment of the present invention, the system observes first interactions of a plurality of first users with a first website. Responsively to the first interactions, the system defines a plurality of communities, each of which includes some of the first users, and generates respective community profiles for the communities. For some applications, the community profiles comprise community association graphs. The system presents, to a second user different from the first users, an interactive advertisement that advertises the first website, when the second user visits a second website different from the first website. The generates a profile of the second user, such as a PAG, as described hereinabove. Upon finding that the profile of the second user correlates with one of the community profiles, the system configures an interactive element of the interactive advertisement using the community profile. For some applications, the interactive element comprises search functionality of the interactive advertisement, as described hereinabove. Alternatively, the profiles may comprise simpler data structures, such as lists of terms.

For some applications, the first interactions include searches performed by the first users including respective search queries having query terms, and the system generates the community profiles by including at least a portion of the query terms in the community profiles. For example, the community profiles may include respective community association graphs, each of which includes some of the query terms as vertices.

For some applications, the system generates the profile of the second user by deriving the profile at least in part from search terms included in a referrer URL of a request received from the second user to access the second website. Alternatively or additionally, the system generates the profile of the second user by including terms from previous searches conducted by the second user.

In an embodiment of the present invention, advertisement system 20 presents to user an advertisement that advertises a first website, when the user visits a second website different from the first website. The advertisement includes at least one navigation element (e.g., a hyperlink) directed to the first website. Upon the user activating the navigation element, the system selects one of a plurality of webpages of the first website responsively to a profile of the user, and presents the selected webpage to the user. In other words, the destination of the navigation element is individually configured for each user based on the user's personal profile.

For some applications, the system makes the selection by calculating a correlation between the profile of the user and a profile of the first website. Responsively to the correlation, the system determines subject matter of the first website that may be of interest to the user, and selects the one of the plurality of webpages because it includes at least some of the subject matter.

Alternatively or additionally, the system makes the selection by generating one or more terms that are correlated between the profile of the user and a profile of the first website, and performing a search of the first website using the one or more terms as a query. The system selects the one of the plurality of webpages because it is a high-ranking result of the search.

For some applications, the user includes a first user, and the system makes the selection by observing interactions with the first website of a plurality of second users different from the first user. For example, the interactions may include search interactions, as described hereinabove. Responsively to the interactions, the system defines a plurality of communities, each of which includes some of the second users, and generates respective community profiles for the communities. The system finds with which of the community profiles the profile of the first user most highly correlates, and selects the one of the plurality of webpages because it includes subject matter reflected in the most highly correlated of the community profiles.

For some applications, the system generates the profile of the user by deriving the profile at least in part from search terms included in a referrer URL of a request received from the user to access the second website. Alternatively or additionally, the system generates the profile of the user by including terms from previous searches conducted by the user. For example, the profile of the user may comprise a PAG, as described hereinabove. Similarly, the profile of the first website may comprise a site association graph (SAG), as described hereinabove. For applications in which the profiles comprise association graphs, the system generally finds correlations between the graphs using techniques described in above-mentioned International Patent Application PCT/US07/67103. Alternatively, the profiles may comprise simpler data structures, such as lists of terms.

In some embodiments of the present invention, advertisement system 20 uses profiles that do not comprise association graphs, such as lists (e.g., ranked lists), vectors, sets of sets, and a non-associative multi-dimensional matrix (e.g., three or more dimensions). For example, the system may use personal profiles that do not comprise PAGs or session association graphs, topic profiles that do not comprise TAGs, document profiles that do not comprise DAGs, global profiles that do not comprise GAGs, and/or group profiles that do not comprise GRAGs.

The word “document,” as used in the present application, including the claims, is to be understood broadly as referring to any digital unit of information, including, but not limited to, files (e.g., containing text, media, or hyperlinks), Web pages, newsgroup postings, and e-mails, which can be stored electronically on a computer or a network. The word “webpage,” as used in the present application, including the claims, is to be understood broadly as referring to any document transmitted over a private or public computer network, such as the Internet, for presentation in a viewer application, such as a browser.

In some embodiments of the present invention, the search techniques described herein are combined with contextual search techniques known in the art.

Techniques of embodiments of the present invention typically improve the efficiency of searching, and conserve the use of computer resources.

The scope of the present invention includes embodiments described in the following applications, which are assigned to the assignee of the present application and are incorporated herein by reference. In an embodiment, techniques and apparatus described in one or more of the following applications are combined with techniques and apparatus described herein:
International Patent Application PCT/US07/67103, filed Apr. 20, 2007, entitled, “Search techniques using association graphs”;
U.S. patent application Ser. No. 11/633,461, filed Dec. 5, 2006, entitled, “A multi-directional and auto-adaptive relevance and search system and methods thereof”;
U.S. Provisional Patent Application 60/793,253, filed Apr. 20, 2006, entitled, “Methods for using association graphs in search engines”;
U.S. Provisional Patent Application 60/796,188, filed May 1, 2006, entitled, “Apparatus and methods thereof for search engine personalization”;
U.S. Provisional Patent Application 60/829,136, filed Oct. 11, 2006, entitled, “Apparatus and methods thereof for search phrase refinement”;
U.S. Provisional Patent Application 60/829,135, filed Oct. 11, 2006, entitled, “Apparatus and methods thereof for using explicit query refinements to tune search results ranking factors”;
U.S. Provisional Patent Application 60/829,132, filed Oct. 11, 2006, entitled, “Apparatus and methods thereof for adaptive ranking mechanism using association graphs and contextual analysis”;
U.S. Provisional Patent Application 60/886,193, filed Jan. 23, 2007, entitled, “Multi-directional and auto-adaptive relevance and search system and methods thereof”;
U.S. Provisional Patent Application 60/887,580, filed Jan. 31, 2007, entitled, “Searchable banner display and apparatus that enables exploring destination content prior to reaching it”;
U.S. Provisional Patent Application 60/741,902, filed in Jan. 2006, entitled, “A multi-directional and auto-adaptive relevance and search system and methods thereof”; and
U.S. patent application Ser. No. 11/846,213, filed Aug. 28, 2007, entitled, “Search phrase refinement by search term replacement.”

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A computer-implemented method comprising:
presenting, to first users that visit one or more first websites, an interactive advertisement that includes search functionality for searching a second website different from the first websites;
receiving from the first users, via a search field of the search functionality, respective first search queries, each of which consists of one or more first query terms;
presenting to the first users respective first search result listings, each of which includes first search results associated with respective search result documents of the second website;
constructing an advertisement profile for the advertisement that represents interactions between the first users and a plurality of the first search results;
presenting the advertisement to a second user that visits one of the first websites; and
configuring the search functionality responsively to the advertisement profile.

2. The method according to claim 1, wherein constructing the advertisement profile comprises:
responsively to the interactions, defining a plurality of communities, each of which includes some of the first users;
generating respective community profiles for the communities and storing the community profiles in the advertisement profile;
receiving a profile of the second user; and
upon finding that the profile of the second user correlates with one of the community profiles, configuring search functionality using the community profile.

3. The method according to claim 1, wherein the advertisement profile includes an advertisement association graph (AAG) that includes at least a portion of the first query terms as vertices.

4. The method according to claim 3, wherein constructing the advertisement profile comprises including as one of the vertices a term included in a user profile of one of the first users, which term was not included in the respective one of the first search queries.

5. The method according to claim 1, wherein configuring the search functionality comprises:
receiving from the second user a second search query, via the search field;
responsively to the second search query, generating a second search result listing including documents of the second website;
ranking at least a portion of the second search result listing responsively to a comparison of the advertisement profile and at least a portion of the documents of the second search result listing; and
presenting at least a portion of the ranked second search result listing to the second user in the advertisement.

6. (canceled)

7. The method according to claim 1, wherein configuring the search functionality comprises:
receiving from the second user a second search query, via the search field;
responsively to the second search query, selecting at least one of the first query terms for inclusion in a set of refinement terms, responsively to a level of association in the advertisement profile of the first query term with the second query terms;
presenting the set of refinement terms to the second user in the advertisement;
responsively to a selection of one of the refinement terms by the second user, adding the selected refinement term to the second search query to generate a third search query; and presenting, to the second user in the advertisement, a second search result listing responsively to the third search query.

8. (canceled)

9. A computer-implemented method comprising:
presenting an interactive advertisement to a plurality of first users that visit one or more first websites, which advertisement includes a search field for searching a second website different from the first websites;
during searches performed by the first users, receiving from the first users respective search queries via the search field;
presenting to the first users respective search result listings;
constructing an advertisement profile for the advertisement that represents interactions between the first users and the advertisement during the searches;
analyzing content of at least one webpage of a third website different from the second website, to generate a set of one or more webpage keywords characterizing the webpage;
determining a level of relevance of the interactive advertisement to the webpage by performing a comparison of the webpage keywords and the advertisement profile; and
presenting the advertisement to a second user that visits the third website, responsively to the level of relevance.

10. The method according to claim 9, wherein each of the search queries consists of one or more query terms, and wherein constructing the advertisement profile comprises including at least a portion of the query terms in the advertisement profile.

11-12. (canceled)

13. The method according to claim 9, wherein each of the search queries includes one or more query terms, wherein the advertisement profile comprises an advertisement association graph (AAG), and wherein constructing the advertisement profile comprises including at least a portion of the query terms as vertices of the AAG.

14. A computer-implemented method comprising:
receiving, via a network, a request from a user to access a webpage of a first website;
examining a referrer URL to determine whether the user was referred to the webpage from a search engine;
upon finding that the user was referred, extracting from the referrer URL a first search query entered by the user into the search engine;
presenting to the user an interactive advertisement that includes a search field for searching a second website different from the first website;
populating the search field with a default second search query determined responsively to the first search query;
upon receiving an indication from the user to perform a search using the default second search query, generating search results by performing a search of the second website using the default second search query; and
presenting at least a portion of the search results to the user in the interactive advertisement.

15. A computer-implemented method comprising:
presenting, to a user visiting a first website, an interactive advertisement that includes a search field for searching a second website different from the first website;
receiving a search query from the user via the search field;
generating a first set of search results by performing a search of the second website using the search query;
upon finding that a relevancy of the first set of search results to the search query does not exceed a threshold relevancy, generating a second set of search results by performing, using the search query, a search of a third website different from the first and second websites; and
presenting at least a portion of the second set of search results in the interactive advertisement.

16. A computer-implemented method comprising:
observing first interactions of a plurality of first users with a first website;
responsively to the first interactions, defining a plurality of communities, each of which includes some of the first users;
generating respective community profiles for the communities;
presenting, to a second user different from the first users, an interactive advertisement that advertises the first website, when the second user visits a second website different from the first website;
receiving a profile of the second user; and
upon finding that the profile of the second user correlates with one of the community profiles, configuring an interactive element of the interactive advertisement using the community profile.

17. The method according to claim 16, wherein the first interactions include searches performed by the first users including respective search queries having query terms, and wherein generating the community profiles comprises including at least a portion of the query terms in the community profiles.

18. The method according to claim 17, wherein the community profiles include respective community association graphs, each of which includes some of the query terms as vertices.

19. The method according to claim 16, wherein the interactive element comprises search functionality of the interactive advertisement.

20. The method according to claim 16, wherein receiving the profile of the second user comprises deriving the profile at least in part from search terms included in a referrer URL of a request received from the second user to access the second website.

21. The method according to claim 16, wherein receiving the profile of the second user comprises including terms from previous searches conducted by the second user.

22. A computer-implemented method comprising:
generating a profile for an internet advertisement;
receiving, via a network, at least one request from at least one first user to access a webpage;
examining a referrer URL of the request to determine whether the first user was referred to the webpage from a search engine;
upon finding that the first user was referred, extracting from the referrer URL a search query entered by the first user into the search engine;
generating a set of one or more webpage keywords characterizing the webpage, which set includes one or more terms of the search query extracted from the referrer URL;
determining a level of relevance of the advertisement to the webpage by performing a comparison of the webpage keywords and the advertisement profile; and
presenting the advertisement to a second user that visits the webpage, responsively to the level of relevance.

23. A computer-implemented method comprising:
presenting to a user an advertisement that advertises a first website, when the user visits a second website different from the first website, the advertisement including at least one navigation element directed to the first website;
receiving a profile of the user; and
upon the user activating the navigation element, selecting one of a plurality of webpages of the first website responsively to the profile of the user, and presenting the selected webpage to the user.

24. The method according to claim 23, wherein selecting comprises:
calculating a correlation between the profile of the user and a profile of the first website;
responsively to the correlation, determining subject matter of the first website that may be of interest to the user; and
selecting the one of the plurality of webpages because it includes at least some of the subject matter.

25. The method according to claim 23, wherein selecting comprises:
generating one or more terms that are correlated between the profile of the user and a profile of the first website;
performing a search of the first website using the one or more terms as a query; and
selecting the one of the plurality of webpages because it is a high-ranking result of the search.

26. The method according to claim 23, wherein the user includes a first user, and wherein selecting comprises:
observing interactions with the first website of a plurality of second users different from the first user;
responsively to the interactions, defining a plurality of communities, each of which includes some of the second users;
generating respective community profiles for the communities;
finding with which of the community profiles the profile of the first user most highly correlates; and
selecting the one of the plurality of webpages because it includes subject matter reflected in the most highly correlated of the community profiles.

27. The method according to claim 23, wherein receiving the profile of the user comprises deriving the profile at least in part from search terms included in a referrer URL of a request received from the user to access the second website.

28. The method according to claim 23, wherein receiving the profile of the user comprises including terms from previous searches conducted by the user.

29. A computer-implemented method comprising:
receiving, from first users performing searches on a first website, a plurality of search queries, each of which comprises one or more query terms;
constructing at least one association graph that includes at least a portion of the query terms as vertices;
presenting, to a second user different from the first users, an interactive advertisement that advertises the first website, when the second user visits a second website different from the first website; and
using the association graph, configuring search functionality of the interactive advertisement for searching the first website.

30-36. (canceled)

37. Apparatus comprising:
an interface; and
a processor, which is configured to present, via the interface, to first users that visit one or more first websites, an interactive advertisement that includes search functionality for searching a second website different from the first websites; receive from the first users, via a search field of the search functionality, respective first search queries, each of which consists of one or more first query terms; present to the first users respective first search result listings, each of which includes first search results associated with respective search result documents of the second website; construct an advertisement profile for the advertisement that represents interactions between the first users and a plurality of the first search results; present the advertisement to a second user that visits one of the first websites; and configure the search functionality responsively to the advertisement profile.

38-50. (canceled)

51. A computer software product comprising a tangible computer-readable medium in which program instructions are stored, which instructions, when read by a computer, cause the computer to present to first users that visit one or more first websites, an interactive advertisement that includes search functionality for searching a second website different from the first websites; receive from the first users, via a search field of the search functionality, respective first search queries, each of which consists of one or more first query terms; present to the first users respective first search result listings, each of which includes first search results associated with respective search result documents of the second website; construct an advertisement profile for the advertisement that represents interactions between the first users and a plurality of the first search results; present the advertisement to a second user that visits one of the first websites; and configure the search functionality responsively to the advertisement profile.

52-58. (canceled)
